(19) United States
(12) Patent Application Publication
(10) Pub. No.: US 2026/0329880 A1
(43) Pub. Date: Oct. 22, 2026

(54) SYSTEM, METHOD, APPARATUS FOR DATA SHARING AND STORAGE MEDIUM

(71) Applicant: Beijing Zitiao Network Technology Co., Ltd., Beijing (CN)

(72) Inventors: Handa LIU, Beijing (CN); Jian WANG, Beijing (CN)

(21) Appl. No.: 19/484,171

(22) PCT Filed: Nov. 1, 2024
(86) PCT No.: PCT/CN2024/129454

§ 371 Date: Nov. 13, 2025

(30) Foreign Application Priority Data
Nov. 3, 2023 (CN) 202311460088.0

(51) Int. Cl. G06F 16/25

(52) U.S. Cl. CPC G06F 16/25

(57) ABSTRACT

A system, a method, an apparatus, a device for data sharing and a storage medium are provided. The system includes: a first control subsystem including a first storage node and configured to write first data from a first data region into the first storage node; and a second control subsystem different from the first control subsystem and configured to send the first data from the first storage node to a second data region different from the first data region.

The present application claims priority to Chinese Patent Application No. 202311460088.0, filed on Nov. 3, 2023, and entitled “SYSTEM, METHOD, APPARATUS FOR DATA SHARING AND STORAGE MEDIUM”, the entire content of which is incorporated hereby by reference.

### FIELD

Example embodiments of the present disclosure generally relate to the field of computers, and in particular, to a system, a method, an apparatus, a device for data sharing and a computer-readable storage medium.

### BACKGROUND

In today's digital age, digital data has been widely used in various fields of production and life. To enhance reliability, many existing data products provide data backup and disaster recovery mechanisms. For this purpose, it is necessary to share data between different sites (for example, different data centers and different computer rooms). For example, data generated by one machine is backed up on another machine, and the backed-up data is restored to the original machine when necessary. In such a process of data sharing, data security issues are particularly important.

### SUMMARY

According to a first aspect of the present disclosure, a system for data sharing is provided, including: a first control subsystem including a first storage node, and is configured to write first data from a first data region into the first storage node; and a second control subsystem different from the first control subsystem and configured to send the first data from the first storage node to a second data region different from the first data region.

According to a second aspect of the present disclosure, a method for data sharing is provided, including: receiving, by a first control subsystem in a system for data sharing, first data from a first data region; writing, by the first control subsystem, the first data into a first storage node of the first control subsystem; and sending, by a second control subsystem in the system, the first data from the first storage node to a second data region different from the first data region, the second control subsystem being different from the first control subsystem.

According to a third aspect of the present disclosure, an apparatus for data sharing is provided, including: a first data receiving module configured to cause a first control subsystem in a system for data sharing to receive first data from a first data region; a first data storage module configured to cause the first control subsystem to write the first data into a first storage node of the first control subsystem; and a first data sending module configured to cause a second control subsystem in the system to send the first data from the first storage node to a second data region different from the first data region, the second control subsystem being different from the first control subsystem.

According to a fourth aspect of the present disclosure, an electronic device is provided. The system includes: a first control subsystem; a second control subsystem; at least one processing unit; and at least one memory being coupled to the at least one processing unit and storing instructions for execution by the at least one processing unit. The instructions, when executed by the at least one processing unit, cause the device to perform the method of the second aspect.

According to a fifth aspect of the present disclosure, a computer-readable storage medium is provided. The computer-readable storage medium has a computer program stored thereon, the computer program being executable by a processor to implement the method of the second aspect.

It should be understood that the content described in the Summary section is neither intended to limit key or essential features of embodiments of the present disclosure, nor is it intended to limit the scope of the present disclosure. Other features of the present disclosure will become easy to understood through the following description.

### BRIEF DESCRIPTION OF THE DRAWINGS

The above and other features, advantages, and aspects of various embodiments of the present disclosure will become more apparent in combination with the accompanying drawings and with reference to the following detailed description. In the accompanying drawings, the same or similar reference symbols refer to the same or similar elements, where:

FIG. 1 shows a schematic diagram of an example environment in which embodiments of the present disclosure may be implemented;

FIG. 2 shows a schematic diagram of one example of a system for data sharing according to some embodiments of the present disclosure;

FIG. 3 shows a schematic architecture diagram of the system for data sharing according to some embodiments of the present disclosure;

FIG. 4 shows a schematic diagram of a data production and backup environment according to some embodiments of the present disclosure;

FIG. 5 shows a flowchart of a process of data sharing according to some embodiments of the present disclosure;

FIG. 6 shows a schematic structural block diagram of an apparatus for data sharing according to some embodiments of the present disclosure; and

FIG. 7 shows a block diagram of an electronic device in which one or more embodiments of the present disclosure may be implemented.

### DETAILED DESCRIPTION

It may be understood that before the technical solutions disclosed in various embodiments of the present disclosure are used, the user should be informed of the type, range of use, use scenarios, or the like of personal information involved in the present disclosure in an appropriate manner according to related laws and regulations, and the authorization of the user should be obtained.

For example, in response to receiving an active request from a user, prompt information is sent to the user to clearly prompt the user that the requested operation will require access to and use of the user's personal information. Therefore, the user may be caused to independently choose, based on the prompt information, whether to provide the personal information to software or hardware such as an electronic device, an application, a server, or a storage medium that performs the operations of the technical solutions of the present disclosure.

As an optional but non-limiting implementation, in response to receiving the active request from the user, the form of sending the prompt information to the user may be such as a form of pop-up window, in which the prompt information may be presented in a form of text. Furthermore, the pop-up window may also carry a selection control for the user to choose whether to “agree” or “disagree” to provide the personal information to the electronic device.

It may be understood that the above process of notifying and obtaining user authorization is only illustrative, and does not constitute a limitation on the implementations of the present disclosure, and other manners that satisfy the relevant laws and regulations may also be applied in the implementations of the present disclosure.

It may be understood that the data involved in the technical solution (including but not limited to the data itself, obtaining or using of the data) should comply with the requirements of corresponding laws, regulations, and related rules.

Embodiments of the present disclosure will be described in more detail below with reference to the accompanying drawings. Although certain embodiments of the present disclosure are shown in the drawings, it would be appreciated that the present disclosure may be implemented in various forms and should not be interpreted as being limited to embodiments set forth here. On the contrary, these embodiments are provided for a more thorough and complete understanding of the present disclosure. It would be appreciated that the accompanying drawings and embodiments of the present disclosure are only for example purposes and are not intended to limit the protection scope of the present disclosure.

It should be noted that the titles of any section/subsection provided herein are not restrictive. Various embodiments are described throughout herein, and any type of embodiment may be included under any section/subsection. In addition, embodiments described in any section/subsection may be combined in any way with any other embodiments described in the same section/subsection and/or different section/subsection.

As used herein, unless explicitly stated, performing a step “in response to A” does not mean that the step is performed immediately after “A”, but may include one or more intermediate steps.

In the description of embodiments of the present disclosure, the term “including” and similar terms thereof should be understood as open-ended inclusion, that is, “including but not limited to”. The term “based on” should be understood as “at least partly based on”. The term “one embodiment” or “this embodiment” should be understood as “at least one embodiment”. The term “some embodiments” should be understood as “at least some embodiments”. Other explicit and implicit definitions may also be included below. The terms “first” and “second” and the like may refer to different or same objects. Other explicit and implicit definitions may also be included below.

As briefly mentioned above, measures need to be taken to ensure data security in the process of data sharing. In some data protection solutions, an applied data product has a disaster recovery mechanism. Disaster recovery mechanisms such as multi-computer room in different locations are provided for the risk of physical data damage, such as aging equipment, natural disasters, and human physical intrusion, which may cause damage to some physical storage. However, all disaster recovery copies are logically unified and may not address human logical tampering and deletion.

In some other data protection solutions, an applied data product has a data backup mechanism. Data backup mechanisms such as a data recycle bin are mainly provided for user accidental deletion recovery. However, such a mechanism does not achieve complete isolation in terms of physical storage location and backup data permission control, and thus may not resist extreme risk situations such as external encryption ransom and malicious data deletion by an attacker.

In general, although traditional data backup may recover data accidentally deleted by a user, the physical storage location of the data and the control of data backup permission are not completely isolated, so it is impossible to resist malicious attacks by hackers or insiders. Although the disaster recovery mechanism may effectively reduce the risk of physical data damage, its copies are logically unified and may not resist man-made logical tampering and malicious deletion.

In order to at least partially address one or more of the above issues, embodiments of the present disclosure provide a solution for data sharing. According to various embodiments of the present disclosure, the followings are applied: a first control subsystem including a first storage node is used to write first data of a first data region into the first storage node, and then a second control subsystem different from the first control subsystem is used to send the first data from the first storage node to a second data region different from the first data region.

In embodiments of the present disclosure, reading data from one data region and writing the data into another data region are performed by different (for example, independent) subsystems. That is, data reading and data writing in the process of data sharing may be isolated, so that a security issue in one data region may be prevented from affecting another data region. In this way, secure data sharing may be advantageously implemented.

In some embodiments, the first control subsystem and the second control subsystem may be independent from each other in at least one of an operating system or a permission configuration. This may effectively prevent the data from being externally invaded and internally tampered.

In some embodiments, the first control subsystem is connected to the first data region through a first network, and the second control subsystem is connected to the second data region through a second network isolated from the first network. For example, one of the first data region and the first data region may be a data production region, and the other data region is a data backup region. The connection to the data production region applies the Internet, and the connection to the data backup region applies a local area network that is not connected to an external network. Using the local area network that is not connected to the external network for data transmission and backup may completely eliminate the possibility of external intrusion, and may also effectively transmit the data between different data regions. Therefore, with embodiments of the present disclosure, the security performance of data sharing may be greatly improved while maintaining stable data transmission.

Example embodiments of the present disclosure are described below with reference to the drawings.

### Example System and Operations

FIG. 1 shows a schematic diagram of an example environment 100 in which embodiments of the present disclosure may be implemented. The environment 100 includes a first data region 110, a relay region 120, and a second data region 130. Data in the first data region 110 and the second data region 130 is transmitted between the two data regions through the relay region 120. The relay region 120 includes a system for data sharing 125, which is also referred to as the system 125 below for short. The system 125 may be implemented by, for example, an electronic device.

As briefly mentioned above, in case of direct data sharing between different data regions through a network, the data may not be fully protected, furthermore, the data is easy for hacker intrusion or insider tampering. To enable relatively secure data sharing between the first data region 110 and the second data region 130, in embodiments of the present disclosure, the relay region 120 is set in the environment 100. At least a part of the system 125 in the relay region 120 may transmit data in an offline state without being connected to the Internet, so that the requirement of preventing external intrusion in the process of data sharing may be fulfilled.

As shown in FIG. 1, as an example, the first data region 110 may include a plurality of hosts 111 and a front-end server 112. Similarly, the second data region 130 may include a plurality of hosts 131 and a front-end server 132. The front-end server 121 and the front-end server 132 may be machines similar to the host 111 and the host 131, respectively, and are used for data aggregation and/or distribution in the process of data sharing. Taking data transmission from the first data region 110 to the second data region 130 as an example, the front-end server 112 may aggregate data or information of data (for example, addresses) that need to be shared (for example, backed up) in each of the hosts 111, and send the aggregated data or information to the relay region. Correspondingly, the front-end server 132 may distribute data from the relay region 120 to the corresponding host 131. It should be understood that although only one front-end server 112 and one front-end server 132 are shown in FIG. 1, this is only an example and not intended to be limiting. In embodiments of the present disclosure, a data region may include any number of front-end servers or may not include a front-end server.

In the environment 100, the illustrated host, front-end server, and system 125 may include any type of devices having a computing capability, including terminal devices or server-side devices. The terminal device may be any type of mobile terminal, fixed terminal or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including the accessories and peripherals of these devices or any combination thereof. The server-side device may include, for example, a computing system/server, such as a mainframe, an edge computing node, or an electronic device in a cloud environment, or the like.

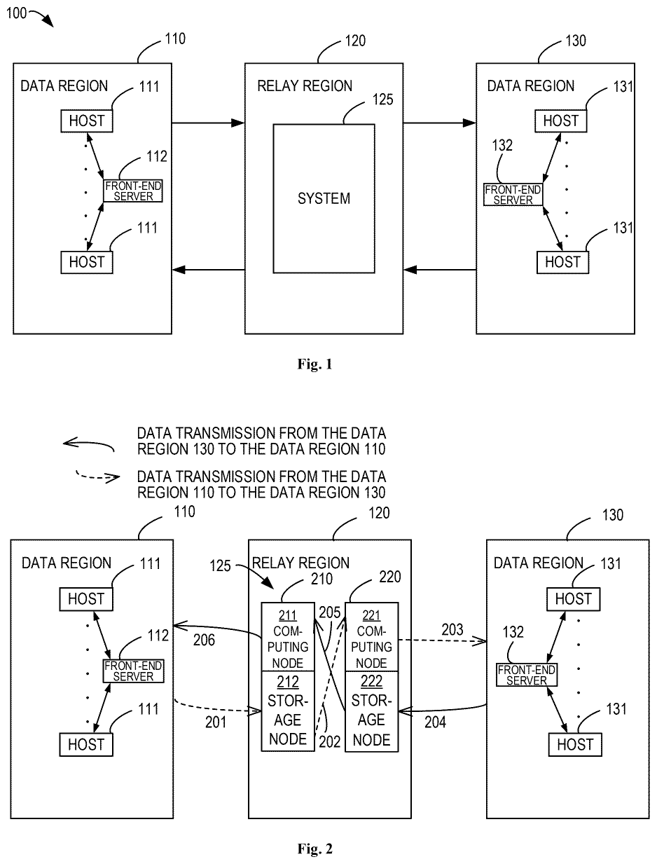

FIG. 2 shows a schematic diagram of an example of a system for data sharing 125 according to some embodiments of the present disclosure. In embodiments of FIG. 2, the system for data sharing 125 includes a first control subsystem 210 and a second control subsystem 220 that are different from each other. The first control subsystem 210 is connected to the first data region 110 for data exchange, and the second control subsystem 220 is connected to the second data region 130 for data exchange.

The first control subsystem 210 includes a first storage node 212 and a first computing node 211. The first control subsystem 210 manages the first storage node 212 storing that under it. For example, the first computing node 211 may implement the management of the first storage node 212. The first computing node 211 and the first storage node 212 may be powered on and off independently. The first control subsystem 210 is configured to write first data from the first data region 110 into the first storage node 212, as shown by an arrow 201.

The second control subsystem 220 is configured to send the first data from the first storage node 212 to the second data region 130, as shown by arrows 202 and 203. Similarly, the second control subsystem 220 may include a second storage node 222 and a second computing node 221. The second control subsystem 220 manages the second storage node 222 storing that under it. For example, the second computing node 221 may implement the management of the second storage node 222. The second computing node 221 and the second storage node 222 may be powered on and off independently. In some embodiments, the second control subsystem 220 may send the first data from the first storage node 212 to the second data region 130 periodically in a first time duration.

In some embodiments, in response to a first preset condition being satisfied, the second control subsystem 220 (for example, the second computing node 221) may take over the first storage node 212 to send the first data from the first storage node 212 to the second data region 130. Furthermore, in response to a second preset condition being satisfied, the second control subsystem 220 (for example, the second computing node 221) may release the first storage node 212. The first preset condition may include a start of the first time duration and/or a reception of an indication that the first data is available. Correspondingly, the second preset condition may include an end of the first time duration and/or a completion of sending the first data.

As an example, if the second control subsystem 220 sends the first data from the first storage node 212 to the second data region 130 periodically in the first time duration, at the start of the first time duration, the second control subsystem 220 may take over the first storage node 212 and send the first data stored therein to the second data region 130. At the end of the first time duration, the second control subsystem 220 may release the first storage node 212 to return the management thereof to the first control subsystem 210. As another example, if an indication that the first data is ready is received, the second control subsystem 220 may take over the first storage node 212. When sending the first data is completed, the second control subsystem 220 may release the first storage node 212.

The transmission of the data from the first data region 110 to the second data region 130 is described above. In some embodiments, the data in the second data region 130 may also be transmitted to the first data region 110. In such embodiments, the second control subsystem 220 may be configured to write second data from the second data region 130 into the second storage node 222, as shown by an arrow 204. The first control subsystem 210 may be further configured to send the second data from the second storage node 222 to the first data region 110, as shown by arrows 205 and 206.

In some embodiments, in response to a third preset condition being satisfied, the first control subsystem 210 (for example, the first computing node 211) may take over the second storage node 222 to send the second data from the second storage node 222 to the first data region 110. Furthermore, in response to a fourth preset condition being satisfied, the first control subsystem 210 (for example, the first computing node 211) may release the second storage node 222. The third preset condition may include a start of a second time duration and/or a reception of an indication that the second data is available. Correspondingly, the fourth preset condition may include an end of the second time duration and/or a completion of sending the second data.

In some embodiments, the first time duration may correspond to a time duration in which the first data stored in the first storage node 212 needs to be transported to the second data region 130 and the second data stored in the second data region 130 needs to be written into the second storage node 222. Correspondingly, the second time duration may correspond to a time duration in which the first data stored in the first data region 110 needs to be written into the first storage node 212 and the second data stored in the second storage node 222 needs to be transported to the first data region 110. For example, the first time duration may be a non-working duration at night, and the second time duration may be a working period in the daytime.

In this way, time-division data transmission between the first data region 110 and the second data region 130 may be advantageously implemented. In this way, even if the first control subsystem 210 is attacked, the data in the second storage node 222 and the second data region 130 may not be affected since the first control subsystem 210 has released the control of the second storage node 222.

In some embodiments, to further enhance the isolation between different data regions and data security, network isolation between the first data region 110 and the second data region 130 may be implemented. Specifically, the first control subsystem 210 may be connected with the first data region 110 through the first network. The second control subsystem 220 may be connected with the second data region 130 through the second network. The first network is isolated from the second network. As an example, in case the first data region 110 is a data production region and the second data region 130 is a data backup region, the first network applies the Internet, and the second network applies a local area network. The local area network is not connected to an external network, and thus transmission and backup of the data between the second control subsystem 220 and the second data region 130 may be caused to completely eliminate the possibility of external intrusion.

In some embodiments, the first control subsystem 210 and the second control subsystem 220 may have operating systems independent from each other. Alternatively or additionally, the first control subsystem 210 and the second control subsystem 220 may have permission configurations independent from each other. With the independent operating systems and/or permission configurations, the isolation between different data regions may be further enhanced.

The first computing node 211 and the first storage node 212 in the first control subsystem 210 may be powered on and off independently, and the second computing node 221 and the second storage node 222 in the second control subsystem 220 may be powered on and off independently. Therefore, in case the first control subsystem 210 is compromised or fails, the second control subsystem 220 may still share data with the second data region 130 through the second network.

The composition and operations of the system 125 are described above. It should be understood that this is only an example. The first control subsystem 210 and the second control subsystem 220 may be implemented using any suitable number and type of devices. Furthermore, the first storage node 212 and the second storage node 222 may include any suitable number and type of storage devices. For example, the first control subsystem 210 and the second control subsystem 220 may include a plurality of servers respectively, and each server may include one or more storage devices to form a storage node.

In the above description, the first control subsystem 210 and the second control subsystem 220 may take over the storage node of each other system. Such takeover may be implemented in various ways, and embodiments of the present disclosure are not limited in this regard. For the purpose of example only and without any limitation, an example is described now with reference to FIG. 3.

FIG. 3 shows a schematic architectural diagram of a system for data sharing 125 according to some embodiments of the present disclosure. The first control subsystem 210 and the second control subsystem 220 include a plurality of storage devices and a plurality of ports connected with the storage devices, respectively. In the example of FIG. 3, the first control subsystem 210 may take over, through a port 303 and a port 333 connected with the port 303, a storage device 321 connected with the port 333, and may take over, through a port 304 and a port 334 connected with the port 304, a storage device 322 connected with the port 334. Similarly, the second control subsystem 220 may take over, through a port 331 and a port 301 connected with the port 331, a storage device 311 connected with the port 301, and may take over, through a port 332 and a port 302 connected with the port 332, a storage device 312 connected to the port 302.

It should be understood that the number and connection relationship of the ports and storage devices shown in FIG. 3 are only an example and not intended to be limiting. Each control subsystem may include any suitable number of ports and storage devices, and each port may be connected with any suitable number of storage devices.

### Example Implementation

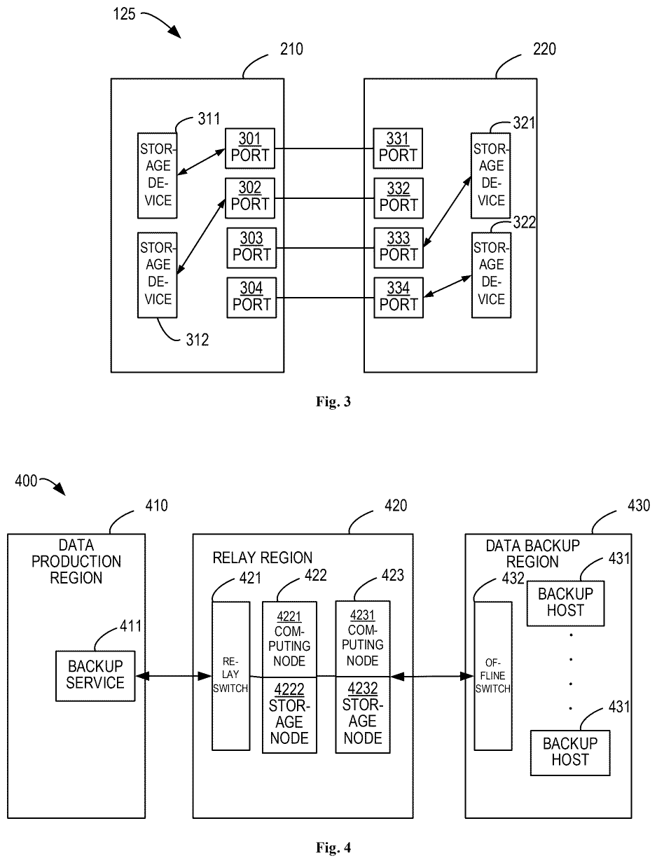

The system for data sharing is described above. An example implementation of such a system in a data production and backup environment is described below. FIG. 4 is a schematic diagram of a data production and backup environment 400 according to some embodiments of the present disclosure. In this example, the data production and backup environment 400 includes a data production region 410, a relay region 420, and a data backup region 430. The relay region 420 is connected between the data production region 410 and the data backup region 430 to implement data sharing between the two regions. The data production region 410 includes a backup service 411 for data transportation and backup. The relay region 420 includes a relay switch 421, a control subsystem 422, and a control subsystem 423. The relay switch 421 is connected to the backup service 411. The control subsystem 422 is connected between the relay switch 421 and the control subsystem 423. The control subsystem 422 includes a computing node 4221 and a storage node 4222, and the control subsystem 423 includes a computing node 4231 and a storage node 4232. The data backup region includes an offline switch 432 and a plurality of backup hosts 431. The offline switch 432 is connected to the control subsystem 423 for data exchange.

Each working period (for example, one day) of the data production and backup environment 400 includes a working time duration (for example, daytime) of the data production region 410 and a working time duration (for example, night) of the data backup region 430. The working time duration of the data production region 410 is different from the working time duration of the data backup region 430. In case the data production and backup environment 400 is in the working time duration of the data production region 410, the backup service 411 in the data production region 410 may store data that needs to be backed up into the storage node 4222 of the control subsystem 422 in the relay region 420 through the relay switch 421. The capacity and network bandwidth of the relay region 420 may be configured based on an actual application scenario.

After the data production and backup environment 400 enters the working time duration of the data production region 410, the control subsystem 423 may take over the storage node 4222 of the control subsystem 422, and the computing node 4231 may transmit the data to the offline switch 432. The offline switch 432 may back up the received data to the plurality of backup hosts 431. At the same time, the control subsystem 423 may also write data in the data backup region 430 that needs to be transmitted to the data production region 410 into the storage node 4232.

After completely transmitting all the data that needs to be transmitted from the data production region 410 to the data backup region 430 to the offline switch 432 or in response to the end of the working time duration of the data backup region 430, the control subsystem 423 may release the control of the storage node 4222.

In case of entering a next working period, the backup service 411 in the data production region 410 stores, through the relay switch 421, data content that needs to be backed up into the storage node 4222 of the control subsystem 422 in the relay region 420. At the same time, the control subsystem 422 may take over the storage node 4232 of the control subsystem 423, and transmit, through the computing node 4221, the data that needs to be transmitted from the data backup region 430 to the data production region 410 to the relay switch 421, so as to import the data into the data production region 410. So far, one working cycle is completed. The entire data sharing and backup work in the data production and backup environment 400 is a repetition of the above cycle.

The control subsystem 423 is connected with the data backup region 430 using an independent local area network, which may effectively avoid external network intrusion. In addition, there is no network channel between the control subsystem 422 and the control subsystem 423, and only data is shared. Therefore, even if a hacker compromises the control subsystem 422 connected to the Internet, the data in the control subsystem 423 and the data backup region 430 will not be affected. At the same time, the data production region 410 and the data backup region 430 use independent operating systems and operation permissions, thereby avoiding man-made tampering and deletion of data by insiders. The computing node 4221, the storage node 4222, the computing node 4231, and the storage node 4232 in the control subsystem 422 and the control subsystem 423 are all powered on and off independently, and hackers may not affect offline operations.

### Example Process

FIG. 5 shows a flowchart of a process of data sharing according to some embodiments of the present disclosure. For example, the process 500 may be implemented at the system 125 for data sharing.

At a block 510, a first control subsystem in a system for data sharing receives first data from a first data region. At a block 520, the first control subsystem writes the first data into a first storage node of the first control subsystem. At a block 530, a second control subsystem in the system sends the first data from the first storage node to a second data region different from the first data region, the second control subsystem being different from the first control subsystem.

In some embodiments, the second control subsystem includes a second storage node, and the method further includes: receiving, by the second control subsystem, second data from the second data region; writing, by the second control subsystem, the second data into the second storage node; and sending, by the first control subsystem, the second data from the second storage node to the first data region.

In some embodiments, sending the first data from the first storage node to the second data region includes: sending, by the second control subsystem, the first data from the first storage node to the second data region periodically in a first time duration; and sending the second data from the second storage node to the first data region includes: sending, by the first control subsystem, the second data from the second storage node to the first data region periodically in a second time duration, and where the second time duration is different from the first time duration.

In some embodiments, the process 500 further includes: taking over, in response to a first predetermined condition being satisfied, the first storage node by the second control subsystem to send the first data to the second data region; and releasing, by the second control subsystem, the first storage node in response to a second predetermined condition being satisfied.

In some embodiments, the first predetermined condition includes at least one of: a start of the first time duration, or a reception of an indication that the first data is available; and the second predetermined condition includes at least one of: an end of the first time duration, or a completion of sending the first data.

In some embodiments, the first control subsystem is connected with the first data region through a first network, the second control subsystem is connected with the second data region through a second network, and the first network is isolated from the second network.

In some embodiments, the first control subsystem and the second control subsystem are independent from each other in at least one of the following: an operating system, or a permission configuration.

In some embodiments, the first data region is a data production region and the second data region is a data backup region, or the first data region is a data backup region and the second data region is a data production region.

### Example Apparatus and Device

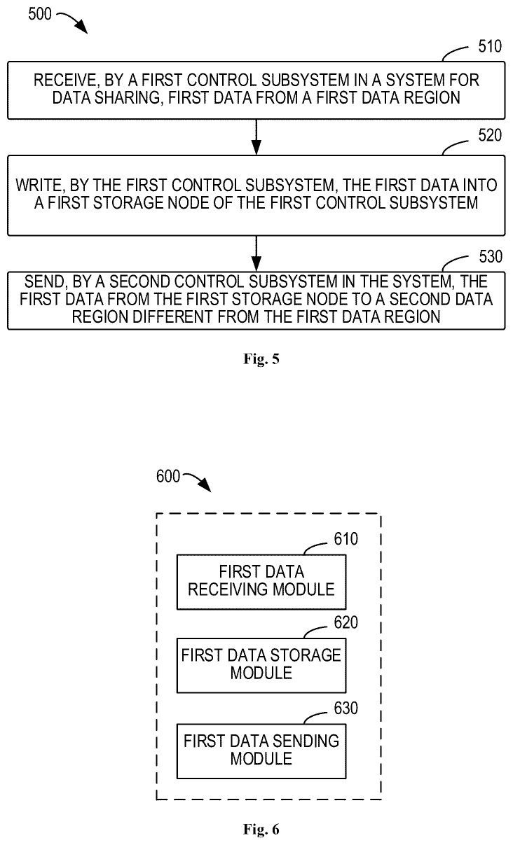

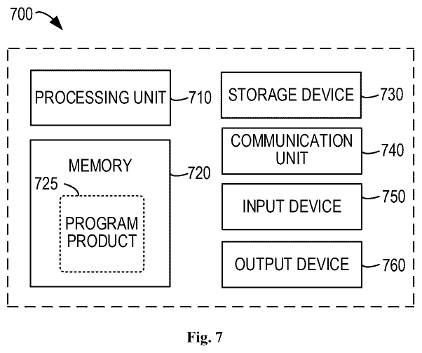

FIG. 6 shows a schematic structural block diagram of an apparatus for data sharing 600 according to some embodiments of the present disclosure. The apparatus 600 may be implemented as or included in the system for data sharing 125. Each module/component in the apparatus 600 may be implemented by hardware, software, firmware, or any combination thereof.

As shown in the figure, the apparatus 600 includes a first data receiving module 610 configured to cause a first control subsystem in a system for data sharing to receive first data from a first data region; a first data storage module 620 configured to cause the first control subsystem to write the first data into a first storage node of the first control subsystem; and a first data sending module 630 configured to cause a second control subsystem in the system to send the first data from the first storage node to a second data region different from the first data region, the second control subsystem being different from the first control subsystem.

In some embodiments, the second control subsystem includes a second storage node, and the apparatus 600 further includes: a second data module configured to cause the second control subsystem to receive second data from the second data region; a second data storage module configured to cause the second control subsystem to write the second data into the second storage node; and a second data sending module configured to cause the first control subsystem to send the second data from the second storage node to the first data region.

In some embodiments, the first data sending module 630 is further configured to: cause the second control subsystem to send the first data from the first storage node to the second data region periodically in a first time duration; and the second data sending module is further configured to: cause the first control subsystem to send the second data from the second storage node to the first data region periodically in a second time duration, and where the second time duration is different from the first time duration.

In some embodiments, the second data sending module is further configured to cause the second control subsystem to take over, in response to a first predetermined condition being satisfied, the first storage node to send the first data to the second data region; and the second data storage module is further configured to cause the second control subsystem to release the first storage node in response to a second predetermined condition being satisfied.

In some embodiments, the first predetermined condition includes at least one of: a start of the first time duration, or a reception of an indication that the first data is available; and the second predetermined condition includes at least one of: an end of the first time duration, or a completion of sending the first data.

In some embodiments, the first control subsystem is connected with the first data region through a first network, the second control subsystem is connected with the second data region through a second network, and the first network is isolated from the second network.

In some embodiments, the first control subsystem and the second control subsystem are independent from each other in at least one of the following: an operating system, or a permission configuration.

In some embodiments, the first data region is a data production region, and the second data region is a data backup region, or the first data region is a data backup region, and the second data region is a data production region.

FIG. 7 shows a block diagram of an electronic device 700 in which one or more embodiments of the present disclosure may be implemented. It would be appreciated that the electronic device 700 shown in FIG. 7 is only an example, and should not constitute any limitation to the functions and scopes of embodiments described herein. Multiple electronic devices such as the electronic device 700 shown in FIG. 7 may be used to implement the system for data sharing 125 in FIG. 1. For example, some electronic devices in these electronic devices may be used to implement the first control subsystem 210 in FIG. 1, and other electronic devices in these electronic devices may be used to implement the second control subsystem 220 in FIG. 1.

As shown in FIG. 7, the electronic device 700 is in the form of a general electronic device. The components of the electronic device 700 may include but not limited to one or more processors or processing units 710, a memory 720, a storage device 730, one or more communication units 740, one or more input devices 750 and one or more output devices 760. The processing unit 710 may be an actual or virtual processor and may execute various processes based on the programs stored in the memory 720. In a multi-processor system, a plurality of processing units execute computer executable instructions in parallel to improve the parallel processing capability of the electronic device 700.

The electronic device 700 typically includes a plurality of computer storage media. Such media may be any available medium accessible by the electronic device 700, including but not limited to volatile and non-volatile medium, and removable and non-removable medium. The memory 720 may be a volatile memory (for example, a register, a cache, a random access memory (RAM)), a non-volatile memory (such as a read-only memory (ROM), an electrically erasable programmable read-only memory (EEPROM), a flash memory), or certain combination thereof. The storage device 730 may be any removable or non-removable medium, and may include a machine readable medium such as a flash drive, a disk, or any other medium, which may be used to store information and/or data and may be accessed within the electronic device 700.

The electronic device 700 may further include additional removable/non-removable, volatile/non-volatile storage medium. Although not shown in FIG. 7, a disk driver for reading from or writing into removable and non-volatile disks (such as a “floppy disk”), and an optical disk driver for reading from or writing into removable and non-volatile optical disks may be provided. In these cases, each driver may be connected to the bus (not shown) by one or more data medium interfaces. The memory 720 may include a computer program product 725, which has one or more program modules configured to execute various methods or acts of various embodiments of the present disclosure.

The communication unit 740 implements communication with other electronic devices through the communication medium. Additionally, the functions of the components of the electronic device 700 may be implemented by a single computing cluster or a plurality of computing machines, which may communicate through communication connections. Therefore, the electronic device 700 may be operated in a networking environment using a logical connection with one or more other servers, a network personal computer (PC) or another network node.

The input device 750 may be one or more input devices, such as a mouse, a keyboard, a tracking ball, etc. The output device 760 may be one or more output devices, such as a display, a speaker, a printer, etc. The electronic device 700 may further communicate with one or more external devices (not shown) through the communication unit 740 as needed, the external devices such as a storage device, a display device, etc., communicate with one or more devices that enable the user to interact with the electronic device 700, or communicate with any devices (such as a network card, a modem, etc.) that enable the electronic device 700 to communicate with one or more other electronic devices. Such communication may be performed via input/output (I/O) interfaces (not shown).

According to an example implementation of the present disclosure, a computer-readable storage medium is provided, having computer executable instructions stored thereon, where the computer executable instructions are executed by a processor to implement the method described above. According to an example implementation of the present disclosure, a computer program product is further provided, the computer program product being tangibly stored on a non-transitory computer-readable medium and including computer executable instructions, and the computer executable instructions are executed by a processor to implement the method described above.

Various aspects of the present disclosure are described herein with reference to the flowcharts and/or block diagrams of the method, the apparatus, the device and the computer program product implemented according to the present disclosure. It would be appreciated that each block of the flowcharts and/or block diagrams, and combinations of various blocks in the flowcharts and/or block diagrams may be implemented by computer-readable program instructions.

These computer-readable program instructions may be provided to the processing unit of a general-purpose computer, a special-purpose computer, or other programmable data processing apparatus to produce a machine, such that when these instructions are executed by the processing unit of the computer or other programmable data processing apparatus, an apparatus for implementing the functions/acts specified in one or more blocks in the flowcharts and/or block diagrams is produced. These computer-readable program instructions may also be stored in a computer-readable storage medium, these instructions enable the computer, the programmable data processing apparatus and/or other devices to work in a specific manner, and thus the computer-readable medium storing the instructions includes a manufactured product, which includes instructions for implementing various aspects of the functions/acts specified in one or more blocks in the flowcharts and/or block diagrams.

The computer-readable program instructions may be loaded onto a computer, another programmable data processing apparatus, or other devices, such that a series of operations and steps are performed on the computer, the other programmable data processing apparatus, or the other devices to generate a computer-implemented process, such that the instructions executed on the computer, the other programmable data processing apparatus, or the other devices implement the functions/acts specified in one or more blocks in the flowcharts and/or block diagrams.

The flowcharts and block diagrams in the drawings show the possibly implemented architectures, functions and operations of the system, the method and the computer program product according to a plurality of implementations of the present disclosure. In this regard, each block in the flowchart or block diagram may represent a module, a program segment or a part of instructions, and the module, the program segment or the part of instructions includes one or more executable instructions for implementing the specified logical functions. In some alternative implementations, the functions marked in the blocks may also occur in an order different from that marked in the drawings. For example, two consecutive blocks may actually be performed substantially in parallel, or may sometimes also be performed in the reverse order, depending on the functions involved. It should also be noted that each block in the block diagrams and/or flowcharts, and the combinations of the blocks in the block diagrams and/or flowcharts may be implemented by a dedicated hardware-based system that executes specified functions or acts, or may be implemented by a combination of dedicated hardware and computer instructions.

Various implementations of the present disclosure have been described above, and the above description is an example and not exhaustive, and is not limited to the disclosed implementations. Without departing from the scope and spirit of the described implementations, many modifications and changes will be apparent to those of ordinary skilled persons in the art. The selection of terms used herein aims to best explain the principles of various implementations, the practical applications, or the improvements to the technologies in the market, or to enable other ordinary skilled persons in the art to understand various implementations disclosed herein.

1. A system for data sharing, comprising:
a first control subsystem comprising a first storage node and configured to write first data from a first data region into the first storage node; and
a second control subsystem different from the first control subsystem and configured to send the first data from the first storage node to a second data region different from the first data region.

2. The system of claim 1, wherein the second control subsystem comprises a second storage node, and
the second control subsystem is further configured to write second data from the second data region into the second storage node, and
the first control subsystem is further configured to send the second data from the second storage node to the first data region.

3. The system of claim 2, wherein the second control subsystem is configured to send the first data from the first storage node to the second data region periodically in a first time duration, and
the first control subsystem is configured to send the second data from the second storage node to the first data region periodically in a second time duration, and wherein the second time duration is different from the first time duration.

4. The system of claim 1, wherein the second control subsystem is further configured to:
take over, in response to a first predetermined condition being satisfied, the first storage node to send the first data to the second data region; and
release the first storage node in response to a second predetermined condition being satisfied.

5. The system of claim 4, wherein the first predetermined condition comprises at least one of: a start of a first time duration, or a reception of an indication that the first data is available, and
the second predetermined condition comprises at least one of: an end of the first time duration, or a completion of sending the first data.

6. The system of claim 1, wherein the first control subsystem is connected with the first data region through a first network, the second control subsystem is connected with the second data region through a second network, and the first network is isolated from the second network.

7. The system of claim 1, wherein the first control subsystem and the second control subsystem are independent from each other in at least one of the following:
an operating system, or
a permission configuration.

8. The system of claim 1, wherein the first data region is a data production region and the second data region is a data backup region, or
the first data region is a data backup region and the second data region is a data production region.

9. A method for data sharing, comprising:
receiving, by a first control subsystem in a system for data sharing, first data from a first data region;
writing, by the first control subsystem, the first data into a first storage node of the first control subsystem; and
sending, by a second control subsystem in the system, the first data from the first storage node to a second data region different from the first data region, the second control subsystem being different from the first control subsystem.

10. The method of claim 9, wherein the second control subsystem comprises a second storage node, and the method further comprises:
receiving, by the second control subsystem, second data from the second data region;
writing, by the second control subsystem, the second data into the second storage node; and
sending, by the first control subsystem, the second data from the second storage node to the first data region.

11. The method of claim 10, wherein sending the first data from the first storage node to the second data region comprises:
sending, by the second control subsystem, the first data from the first storage node to the second data region periodically in a first time duration, and
wherein sending the second data from the second storage node to the first data region comprises:
sending, by the first control subsystem, the second data from the second storage node to the first data region periodically in a second time duration, and wherein the second time duration is different from the first time duration.

12. The method of claim 9, further comprising:
taking over, in response to a first predetermined condition being satisfied, the first storage node by the second control subsystem to send the first data to the second data region; and
releasing, by the second control subsystem, the first storage node in response to a second predetermined condition being satisfied.

13. The method of claim 12, wherein the first predetermined condition comprises at least one of: a start of a first time duration, or a reception of an indication that the first data is available, and
the second predetermined condition comprises at least one of: an end of the first time duration, or a completion of sending the first data.

14. The method of claim 9, wherein the first control subsystem is connected with the first data region through a first network, the second control subsystem is connected with the second data region through a second network, and the first network is isolated from the second network.

15. The method of claim 9, wherein the first control subsystem and the second control subsystem are independent from each other in at least one of the following:
an operating system, or
a permission configuration.

16. The method of claim 9, wherein the first data region is a data production region and the second data region is a data backup region, or
the first data region is a data backup region and the second data region is a data production region.

17. (canceled)

18. An electronic device, comprising:
a first control subsystem;
a second control subsystem;
at least one processor; and
at least one memory coupled to the at least one processor and storing instructions for execution by the at least one processor, the instructions, when executed by the at least one processor, causing the electronic device to perform acts comprising:
receiving, by a first control subsystem in a system for data sharing, first data from a first data region;
writing, by the first control subsystem, the first data into a first storage node of the first control subsystem; and
sending, by a second control subsystem in the system, the first data from the first storage node to a second data region different from the first data region, the second control subsystem being different from the first control subsystem.

19. (canceled)

20. The electronic device of claim 18, wherein the second control subsystem comprises a second storage node, and the acts further comprise:
receiving, by the second control subsystem, second data from the second data region;
writing, by the second control subsystem, the second data into the second storage node; and
sending, by the first control subsystem, the second data from the second storage node to the first data region.

21. The electronic device of claim 20, wherein sending the first data from the first storage node to the second data region comprises:
sending, by the second control subsystem, the first data from the first storage node to the second data region periodically in a first time duration, and
wherein sending the second data from the second storage node to the first data region comprises:
sending, by the first control subsystem, the second data from the second storage node to the first data region periodically in a second time duration, and wherein the second time duration is different from the first time duration.

22. The electronic device of claim 18, wherein the acts further comprise:
taking over, in response to a first predetermined condition being satisfied, the first storage node by the second control subsystem to send the first data to the second data region; and
releasing, by the second control subsystem, the first storage node in response to a second predetermined condition being satisfied.
